(19) United States
(12) Patent Application Publication
(10) Pub. No.: US 2009/0295603 A1
(43) Pub. Date: Dec. 3, 2009

(54) Capsize Alerting Apparatus and Method

(75) Inventors: Cecil Clark, Dorset (GB); Mark Morgan, Dorset (GB)

Correspondence Address: HAVERSTOCK & OWENS LLP, 162 N WOLFE ROAD, SUNNYVALE, CA, 94086, US

(73) Assignee: ROYAL NATIONAL LIFEBOAT INSTITUTION, Poole (GB)

(21) Appl. No.: 11/991,675

(22) PCT Filed: Sep. 8, 2006
(86) PCT No.: PCT/GB2006/003327

§ 371 Date: Jul. 29, 2009

(30) Foreign Application Priority Data
Sep. 9, 2005 (GB) 0518452.8

(51) Int. Cl. G08B 23/00

(52) U.S. Cl. 340/984

(57) ABSTRACT

A capsize alerting apparatus (40) for a maritime vessel (10) is provided. The capsize alerting apparatus comprises an antenna (15) which is fixed on the maritime vessel in an orientation which permits communication with a receiver when the vessel is in a capsized state. The antenna is further operable when the vessel is in the capsized state to transmit a capsize alert message indicating that the vessel has capsized. Accordingly, by fixing an antenna to the vessel in an orientation which permits communication with a receiver when the vessel is in a capsized state, the vessel is able to communicate a capsize alert signal to a receiver (20) even though the vessel is in a capsized state in which a conventional communications system will not function.

### FIELD OF INVENTION

The present invention relates to a capsize alerting apparatus and a method.

### BACKGROUND OF THE INVENTION

For search and rescue services to be able to effectively mount rescue operations following maritime incidents, it is important to provide the search and rescue authorities with an indication that an incident has taken place. While some areas, particularly along coastlines, may provide look out services to raise an alert when a vessel becomes in distress, in other areas no such service is present. It is therefore more reliable for a report of an incident to originate from the vessel in distress itself. One particular incident which may occur is for a vessel to capsize. Different vessels may capsize in different ways. In particular, some types of vessel, for instance a fishing vessel, are likely to rapidly sink following a capsize, while other types of vessel, for instance inflatables, rigid inflatables, and yachts, are more likely to stay afloat for some time.

In the case of vessels likely to float after capsize, there is a possibility that persons could be trapped inside or around the vessel and require rescue from the vessel or its vicinity.

An existing system for alerting of a capsize incident provides a buoy which is releasably attached to a mast of a vessel. The buoy is released from the vessel when a capsize occurs by means of a hydrostatic switch. The buoy comprises a transmitter for transmitting a distress signal upon release from the vessels.

### SUMMARY OF INVENTION

According to a first aspect of the present invention, there is provided a capsize alerting apparatus for a maritime vessel. The capsize alerting apparatus comprises an antenna which is fixed on the maritime vessel in an orientation which permits communication with a receiver when the vessel is in a capsized state. The antenna is further operable when the vessel is in the capsized state to transmit a capsize alert message indicating that the vessel has capsized. The present invention recognises that there is a need to be able to alert a search and rescue agency whilst in a capsized state. The present invention also recognises that the buoys are not normally carried by small vessels and RIBs. The present invention further recognises that many vessels are likely to float after capsize. Accordingly, by fixing an antenna to the vessel in an orientation which permits communication with a receiver when the vessel is in a capsized state, the vessel is able to communicate a capsize alert signal to a receiver even though the vessel is in a capsized state in which a conventional communications system will not function. As a result of this, following a capsize incident, although the conventional ship-board communications system will be non-functional due to submersion of the radio antennae and other elements of the communications system, communication of a distress message is still possible using the capsize alerting apparatus. Also, there is a reduced need to carry a buoy.

In one embodiment, the antenna will be positioned close to, or in another embodiment adjacent to, the hull. For the purposes of this application, the term hull will be taken to include the frame or body of any vessel. The antenna may be mounted inside the hull, either to the inside of the hull itself or to another structure in close proximity to the hull. This arrangement is particularly well suited to vessels having a hull constructed from materials such as Glass Reinforced Plastic (GRP) or rubber because these materials do not significantly attenuate radio signals within at least some of the radio frequency bands suitable for providing distress signal communications.

Alternatively, the antenna could be mounted externally of the hull. This is useful for vessels having a hull constructed of a material providing significant attenuation of radio signals within the applicable radio frequency bands, for instance wood or metal. For some hull types, it may be possible to form the antenna integrally with the hull. For a double skin hull, it may be possible to locate the antenna between the inner and outer skin.

One suitable position for the antenna is at the underside of the hull structure, where it will be close to the uppermost point of the vessel when the vessel is inverted. Alternatively, for a vessel which is likely to lay on its side rather than to invert in the event of a capsize, an antenna could be positioned close to the sides of the hull structure.

The capsize alert system may be provided with a positioning device operable to determine the geographical position of the vessel. The positioning device could for instance be a Global Positioning System (GPS) unit, either integrated with the capsize alert system itself, or possibly an existing shipboard GPS unit used on the ship for navigation purposes. Where a position device is provided, the capsize alert message may specify the geographical position determined by the positioning device. Where the positioning device is integral to the capsize alert system, and in particular is provided in close proximity to the antenna, the positioning device may continue to generate updated position information after the initial transmission of a capsize alert message. In contrast, where the positioning device forms part of the vessels existing navigation system, this may cease to function when the vessel capsizes and therefore no further position updates would be generated. In this case, the capsize alert message will include the most recently generated position data from before the capsize of the vessel.

In one embodiment, the capsize alerting device transmits capsize alert messages at all times, but due to the orientation of the antenna, these messages will not propagate away from the vessel unless the vessel is at least partially inverted in the water. No activation system is therefore strictly required.

However, in another embodiment, the capsize alerting apparatus also includes a capsize detector for detecting that the vessel has capsized and for controlling the antenna to transmit the capsize alert message in response to the detection. As a result of this, power is not wasted in transmitting capsize alert messages when the vessel has not capsized.

It may be helpful for a search and rescue service receiving the capsize alert message to be provided with some information about the vessel. Accordingly, the capsize alert message may include an indication of the identity of the vessel. Vessels using the capsize alerting device may be required to register the device and their vessel with a Search and Rescue service. In this case, the Search and Rescue service can use the identity information in the capsize alert message to determine information such as the size and type of the vessel and the likely number of crew. This information will assist the Search and Rescue service in determining the type and number of rescue vessels and personnel to send out to deal with the capsize incident.

The capsize alerting device may be arranged to transmit further capsize alert messages while the vessel remains in the capsized state. These subsequent messages will improve reliability of the system where the initial message was not received, and will provide the Search and Rescue services with an indication that the vessel is still afloat, and may also, provided that a positioning device is also included within the capsize alerting system, provide an update of the position of the vessel. The capsize alert messages may cease either when the vessel is righted or when the vessel sinks.

In order to provide the crew and passengers of the capsized vessel with an indication that help is on its way, the antenna may be arranged to receive an acknowledgement message communicated to the vessel in response to the capsize alert message. The capsize alerting apparatus will then, in response to the acknowledgement message being received by the antenna, provide an indication that the capsize alert message has been received. This indication could be a visual indicator such as a series of lights switching on throughout the vessel, or could be an audio indicator such as a siren.

The antenna for the capsize alerting apparatus and a GPS antenna could be provided together as a single unit The D+ Inmarsat (trademark) communications service and Iridium (trademark) are possible satellite based communications infrastructures which could be used for communicating capsize alert messages to search and rescue services. However, any suitable communication infrastructure such as, for example, GSM may be used. It will be appreciated that the communication infrastructure need not therefore be satellite based.

According to a second aspect of the present invention, there is provided a method of alerting of a capsize of a maritime vessel. The method comprises the steps of:

fixing an antenna on the maritime vessel in an orientation which permits communication with a receiver when the vessel is in a capsized state; and

transmitting a capsize alert message when the vessel is in the capsized state to indicate that the vessel has capsized.

Various other aspect and features of the present invention are defined in the claims.

### BRIEF DESCRIPTION OF THE DRAWINGS

The present invention will be described further, by way of example only, with reference to preferred embodiments thereof as illustrated in the accompanying drawings, in which:

FIG. 1 schematically illustrates a maritime vessel fitted with a capsize alerting device according to an embodiment of the invention, in which the vessel is in a normal operating state;

FIG. 2 schematically illustrates the maritime vessel in a capsized state;

FIG. 3 schematically illustrates the maritime vessel in another capsized state;

FIGS. 4A to 4D schematically illustrate example mounting locations on a maritime vessel for an antenna of the capsize alerting device according to an embodiment of the invention;

FIG. 5 schematically illustrates the capsize alerting device according to an embodiment of the invention;

FIG. 6 schematically illustrates a method of alerting of a capsize of a maritime vessel according to an embodiment of the invention.

### DESCRIPTION OF EXAMPLE EMBODIMENTS

FIG. 1 schematically illustrates a maritime vessel 10 provided with a capsize alert apparatus 40 in accordance with an embodiment of the invention. Specifically, the maritime vessel 10 is shown in an upright operational position. In this position, an antenna 15 of a conventional radio communications system provided on a mast 12 of the vessel 10 is operable to communicate radio signals to an external receiver on a satellite 20. As an alternative, the antenna 15 may be operable to communicate radio signals to a surface based external receiver. While the maritime vessel 10 is in this position the capsize alerting apparatus 40 will not transmit radio signals to the external receiver, because the vessel 10 has not at this time capsized. Further, even if the capsize alerting apparatus 40 were to transmit radio messages, either due to a malfunction of the alert apparatus 40, or because the apparatus 40 is intended to provide an “always on” transmission, these radio messages will not be able to leave the vicinity of the vessel 10 because the orientation and position of the antenna of the capsize alerting apparatus 40 will cause the radio signals to be transmitted into and absorbed by the water surrounding the vessel 10.

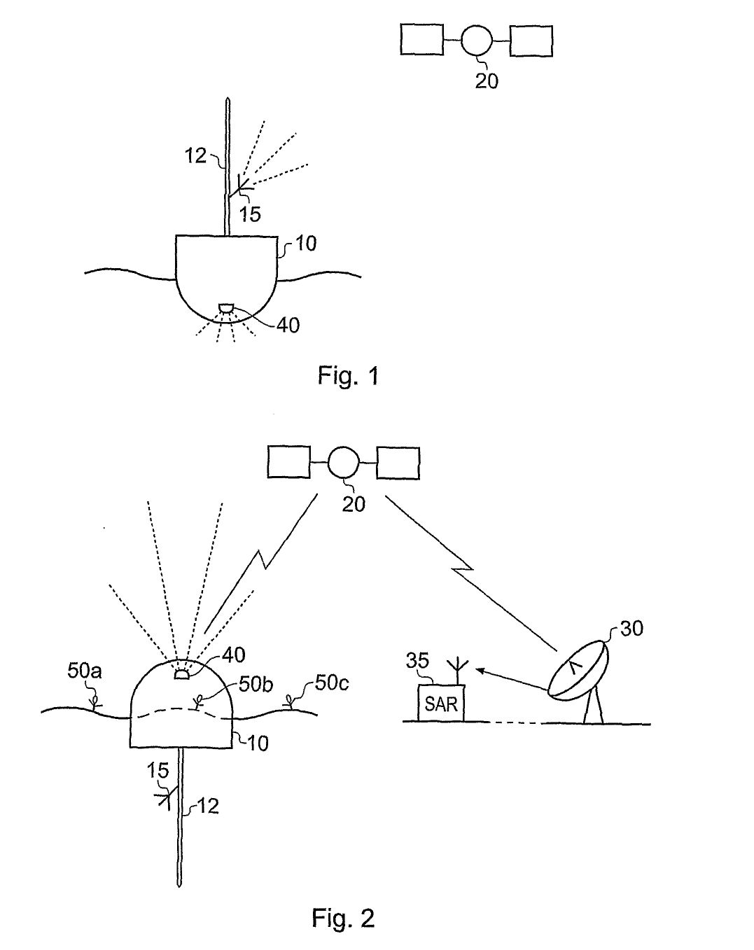

Referring now to FIG. 2, the vessel 10 shown in FIG. 1 is illustrated in a capsized position in which the vessel 10 is inverted such that its deck and mast 15 are fully submerged, and only a portion of the hull remains above the water level. In this state, the antenna 15 of the conventional communications system is unable to communicate with the receiver on the satellite 20 because the antenna 15 is submerged and in the wrong orientation to transmit radio signals to the satellite 20. In a capsize situation such as that shown in FIG. 2, crewmembers and passengers 50a, 50b, 50c of the vessel 10 may be left floating in the water surrounding the vessel 10 or alternatively may be trapped within the vessel 10. The rescue of these crewmembers and passengers relies on search and rescue authorities being notified of the occurrence and location of the capsize. With the vessel 10 in a capsized state, the capsize alerting apparatus 40 is now oriented such that it can transmit a capsize alert message to a receiver on the satellite 20. Specifically, it can be seen that the antenna of the capsize alerting apparatus 40 is now above the water level both inside and outside of the vessel 10.

The capsize alert message transmitted to the satellite 20 provides an indication that a capsize event has taken place. It may also include an indication of the geographical location of the capsize event, a time at which the geographical location was determined and an indication of the identity of the vessel 10. The capsize alert message will then be relayed from the satellite 20 to ground station 30. From the ground station 30, the capsize alert message can be relayed to the relevant search and rescue authority 35. Based on the occurrence and information provided with the capsize alert message, the search and rescue authority 35 can initiate a rescue mission.

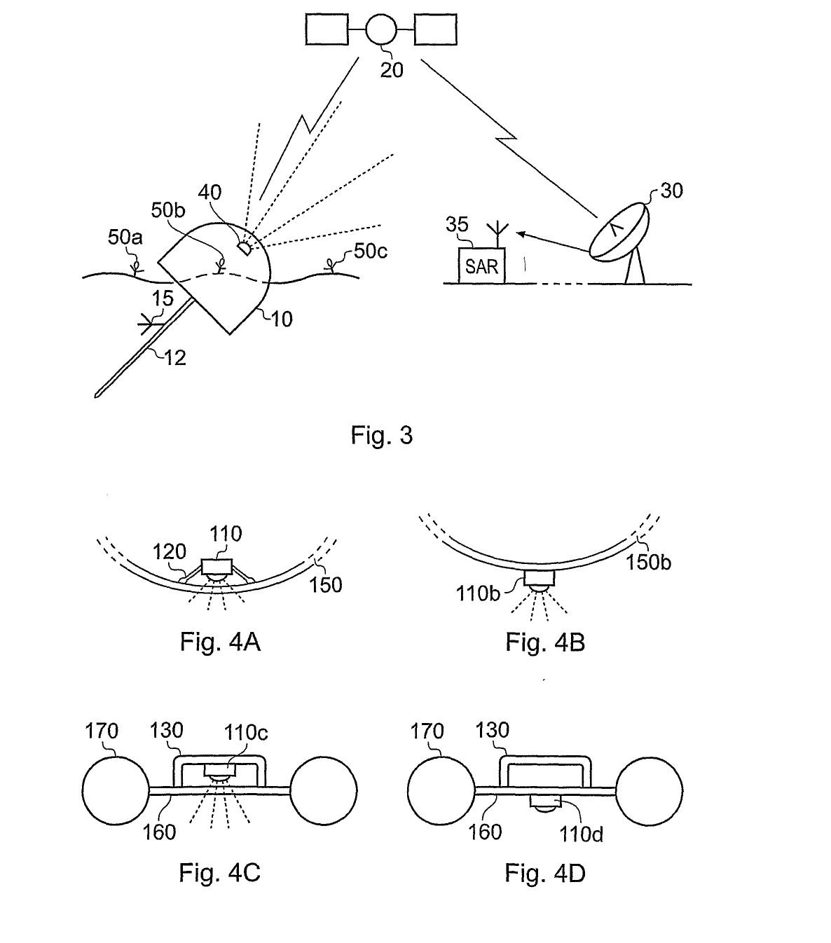

FIG. 3 schematically illustrates the operation of the capsize alerting apparatus 40 when the vessel 10 is in an alternative capsized position. Specifically, while the vessel 10 in FIG. 2 is completely inverted compared to the upright orientation of FIG. 1, the antenna of the capsize alert apparatus 40 is oriented such that it can transmit capsize alert messages to the satellite 20 when the vessel 10 is in a variety of capsize positions, such as the partially inverted position shown in FIG. 3. The features of FIG. 3 are marked with the same reference numerals as the corresponding features of FIG. 2, and will not be described further. It should also be noted that the capsize alerting apparatus 40 need not necessarily be positioned such that it is above sea level when the vessel 10 capsizes, it is only necessary for a substantially uninhibited radio propagation path to exist between the antenna of the capsize alerting apparatus 40 and the satellite 20. These conditions may be satisfied provided that the antenna is not completely submerged within the vessel 10, and provided that a suitable part of the hull of the vessel 10 remains above the water level.

In FIGS. 4a to 4d, options for fixing the capsize alerting apparatus 40 to a vessel 10 are illustrated. While in FIGS. 4a to 4d the capsize alerting apparatus 40 is illustrated as a single integrated unit, the various components of the capsize alerting apparatus 40 could be distributed throughout the vessel 10. In this case, it is important only that the antenna of the capsize alerting apparatus 40 is located such that capsize alert messages can be transmitted at a time when the vessel 10 has capsized. Accordingly, the positions and mechanisms for fixing to a vessel 10 shown in FIGS. 4a to 4d may be equally applicable either to the capsize alerting apparatus 40 as a whole or to only the antenna of the capsize alerting apparatus 40 or to any other subset of the capsize alerting apparatus 40 which includes the antenna.

In FIG. 4a, a capsize alerting apparatus 110 is fixed to the inside of a hull 150 by struts 120 which may be welded or otherwise bonded to the hull 150. By providing the capsize alerting apparatus 110 within the hull 150, it is protected from environmental conditions and hazards presented by the water around the hull. However, providing the capsize alerting apparatus 110 within the hull requires the hull to be made from a material which is substantially transparent to radio signals at the appropriate wavelengths for communication to a receiver. For instance, an example antenna, the D+ antenna, operates using a frequency of approximately 1.6 GHz. Where a GPS unit is to be used to obtain positional information through the hull, the GPS unit may for example operate within the frequency bands 390 Mhz to 1.5 GHz. Referring to FIG. 4b, an alternative arrangement is illustrated in which a capsize alerting apparatus 110b is fixed to the exterior of a hull 150b. Such an arrangement is suitable when the hull is made from a material which is opaque to radio signals at the required wavelengths. The capsize alerting apparatus 110b may be fixed to the exterior of the hull 150b by any suitable method, for instance by riveting or with the use of a waterproof adhesive.

Referring to FIG. 4c, the application of the capsize alerting apparatus to a different ship design is illustrated. Specifically, the design shown in FIG. 4c is that of an inflatable or semi-inflatable vessel such as a RIB, although similar principles may apply for a twin hulled vessel such as a catamaran. The vessel shown in FIG. 4c comprises inflatable elements 170 and a base or deck element 160. A structure 130 present within the vessel is shown in FIG. 4c and may for instance be a seat, but equally be any other fixed structure within the vessel. A capsize alerting apparatus 110c is provided beneath and fixed to the structure 130, and oriented in such a way that when the vessel is capsized the capsized alerting apparatus 110c will be able to transmit radio signals to a receiver. In FIG. 4d, a vessel structure similar to that of FIG. 4c is provided. However, in FIG. 4d, the capsize alerting apparatus is provided on the exterior of the vessel, and in particular beneath the base or deck 160.

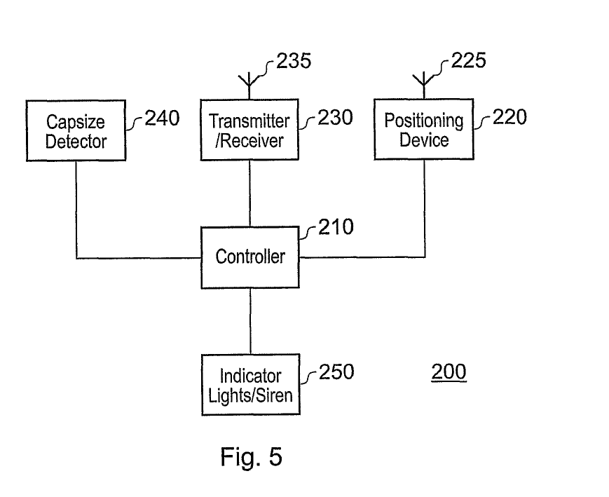

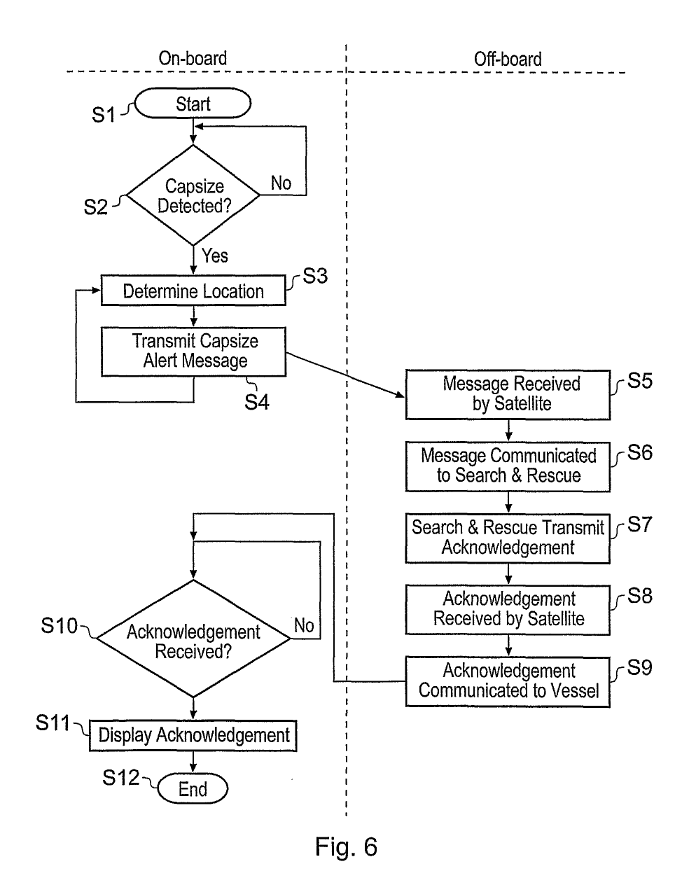

The functional structure of the capsize alerting apparatus is illustrated schematically in FIG. 5. A capsize alerting apparatus 200 in accordance with an embodiment of the invention comprises a controller 210 for controlling the operation of the capsize alerting apparatus 200, and in particular for controlling the generation of capsize alert messages. The controller 210 could be a dedicated hardware apparatus or a suitably programmed data processing apparatus. A capsize detector 240 is provided which detects if the vessel 10 has capsized and communicates an indication that the vessel 10 has capsized to the controller 210. An example capsize detector 240 could be a mercury tilt switch, however any other mechanism capable of determining that the vessel 10 is in a capsized state would also be suitable, including a hydrostatic switch or an inclination detector.

A transmitter/receiver unit 230 is provided which is operable to transmit capsize alert messages to an external receiver and is also operable to receive acknowledgement messages or command messages communicated in response to the capsize alert message. A positioning device 220, in this case, a GPS receiver, is also provided and generates positional information regarding the location of the vessel 10 for inclusion within the capsize alert message transmitted by the transmitter/receiver unit 230. While a dedicated positioning system is advantageous in that it can provide a continual update to the search and rescue services regarding any change to the geographical position of the vessel 10, the capsize alerting apparatus 200 could simply be linked to a positioning system such as a GPS unit used on the vessel 10 for navigational purposes, and could transmit the most recently received geographical data before capsize.

An indicator unit 250 is provided which can provide an indication that an acknowledgement message has been received by the capsize alerting apparatus 200. The indicator unit is intended to provide the crew and any passengers of the vessel 10 with an indication that the capsized state of the vessel 10 is known to the search and rescue authorities and that a rescue operation will soon be underway. The transmitter/receiver unit 230 and the positioning device 220 could be a D+ antenna for the D+ Inmarsat satellite based communications system and a GPS receiver respectively. These units could be provided together as a single unit. The D+ communications system is a low cost service to which the user of the capsize alerting apparatus 200 would need to register. The D+ system uses a Time Division Multiple Access protocol in which the D+ unit monitors an Inmarsat satellite to find a time slot to use, and then requests a message be sent using that time slot.

FIG. 6 schematically illustrates in the form of a flow diagram a capsize alerting method according to an embodiment of the invention. The left-hand side of FIG. 6 sets out the functional operations carried out by the capsize alerting apparatus 40 on board the vessel 10. The right-hand side of FIG. 6 sets out the functional operations carried out externally of the vessel 10. The process starts at step S1. At this stage, no capsize event has been detected. At step S2, the capsize alerting apparatus 40 monitors whether a capsize event has occurred, and when a capsize event has been detected, the geographical location of the vessel 10 is determined by the positioning device of the capsize alerting apparatus 40 at step S3. Then, at step S4, a capsize alert message including an indication of the identity of the vessel 10 and the determined geographical position of the vessel 10 is transmitted. The capsize alerting apparatus 40 will continue to generate updated position information and to transmit capsize alert messages until either the vessel 10 is righted, the vessel 10 sinks, or the capsize alerting apparatus 40 runs out of power.

At step S5, the capsize alert message transmitted by the capsize alerting apparatus 40 will be received by radio receiver on board a satellite. The satellite will, at step S6, communicate the capsize alert message to a relevant search and rescue authority. At step S7, the search and rescue authority will transmit an acknowledgement message back to the satellite. At step S8 the satellite will receive the acknowledgement message from the search and rescue authority and, at step S9 the satellite will relay the acknowledgement message back to the vessel 10 and to the capsize alerting apparatus 40. Meanwhile, the capsize alerting apparatus 40 will monitor for an acknowledgement signal at step S10. Upon receipt of an acknowledgement message, an indicator unit of the capsize alerting apparatus 40 will display, at step S11, an acknowledgement that the search and rescue authorities have received and are dealing with the capsize alert.

Although illustrative embodiments of the invention have been described herein with reference to the accompanying drawings, it is to be understood that the invention is not limited to those precise embodiments, and that various changes and modifications can be affected therein by one scope in the art without departing from the scope of the invention as defined by the appended claims.

1-20. (canceled)

21. A capsize alerting apparatus for a maritime vessel, the capsize alerting apparatus comprising:
an antenna being fixed on the maritime vessel in a position and an orientation which permits the antenna to communicate with a receiver when the vessel is in a capsized state, the antenna being further operable when the vessel is in the capsized state to transmit, from its fixed position on the maritime vessel, a capsize alert message indicating that the vessel has capsized.

22. A capsize alerting apparatus according to claim 21, wherein the antenna is positioned adjacent to a hull of the vessel.

23. A capsize alerting apparatus according to claim 21, comprising a positioning device operable to determine the geographical position of the vessel, and wherein the capsize alert message includes information indicative of the determined geographical position.

24. A capsize alerting apparatus according to claim 21 comprising a capsize detector for detecting that the vessel has capsized and controlling the antenna to transmit the capsize alert message in response to the detection.

25. A capsize alerting apparatus according to claim 21, wherein the capsize alert message comprises an indication of the identity of the vessel.

26. A capsize alerting apparatus according to claim 21, wherein the antenna is operable to transmit further capsize alert messages while the vessel remains in the capsized state.

27. A capsize alerting apparatus according to claim 21, wherein the antenna is operable to receive an acknowledgement message communicated to the vessel in response to the capsize alert message, and wherein the capsize alerting apparatus is operable in response to the acknowledgement message being received by the antenna to provide an indication that the capsize alert message has been received.

28. A capsize alerting apparatus according to claim 21, wherein the antenna is fixed to the outside of the vessel.

29. A capsize alerting apparatus according to claim 21, wherein the antenna is fixed within the vessel.

30. A capsize alerting apparatus according to claim 21, wherein the antenna is integrally formed with a hull of the vessel.

31. A maritime vessel comprising a capsize alerting apparatus according to claim 21.

32. A method of alerting of a capsize of a maritime vessel, comprising the steps of:
fixing an antenna on the maritime vessel in a position and an orientation which permits the antenna to communicate with a receiver when the vessel is in a capsized state; and
transmitting, from the antenna in its fixed position on the maritime vessel, a capsize alert message when the vessel is in the capsized state to indicate that the vessel has capsized.

33. A method of alerting of a capsize of a maritime vessel according to claim 32, comprising the steps of
determining the geographical position of the vessel; and
providing information indicative of the determined geographical position within the capsize alert message.

34. A method of alerting of a capsize of a maritime vessel according to claim 32, comprising the steps of
detecting that the vessel has capsized; and
controlling the antenna to transmit the capsize alert message in response to the detection.

35. A method of alerting of a capsize of a maritime vessel according to claim 32, comprising the step of
providing an indication of the identity of the vessel within the capsize alert message.

36. A method of alerting of a capsize of a maritime vessel according to claim 32, comprising the step of
transmitting further capsize alert messages while the vessel remains in the capsized state.

37. A method of alerting of a capsize of a maritime vessel according to claim 32, comprising the steps of
receiving an acknowledgement message communicated to the vessel in response to the capsize alert message
providing, in response to the acknowledgement message being received by the antenna, an indication that the capsize alert message has been received.

38. A method of alerting of a capsize of a maritime vessel according to claim 32, wherein the antenna is fixed to the outside of the vessel.

39. A method of alerting of a capsize of a maritime vessel according claim 32, wherein the antenna is fixed within the vessel.

40. A method of alerting of a capsize of a maritime vessel according to claim 32, wherein the antenna is integrally formed with a hull of the vessel.

41. A capsize alerting apparatus for a maritime vessel, comprising:
antenna means, fixed on the maritime vessel in a position and an orientation which permits the antenna means to communicate with a receiver when the vessel is in a capsized state, for transmitting from its fixed position on the maritime vessel, when the vessel is in the capsized state, a capsize alert message indicating that the vessel has capsized.
